(19) United States
(12) Patent Application Publication
(10) Pub. No.: US 2023/0207865 A1
(43) Pub. Date: Jun. 29, 2023

(54) Sulfide Solid Electrolyte, A method for Stabilizing Sulfide Solid Electrolyte and a Lithium Battery of the Same

(71) Applicant: National Taiwan University of Science and Technology, Taipei 106 (TW)

(72) Inventors: Bing-Joe Hwang, Taipei (TW); Sheng-Chiang Yang, Taipei (TW); Shi-Kai Jiang, Taipei (TW); Wei-Nien Su, Taipei (TW)

(21) Appl. No.: 17/899,703

(22) Filed: Aug. 31, 2022

(30) Foreign Application Priority Data
Dec. 23, 2021 (TW) 110148457

(51) Int. Cl. H01M 10/0562

(52) U.S. Cl. CPC H01M 10/0562; H01M 10/0525

(57) ABSTRACT

Present invention is related to a method for stabilizing sulfide solid electrolyte having steps of providing a sulfide solid electrolyte, contacting the sulfide solid electrolyte with carbon dioxide gas, and the sulfide solid electrolyte absorbing the CO₂ gas. By introducing cost efficient CO₂ gas, the sulfide solid electrolyte could have a more stable molecular structure to avoid degradation during long cycle lifetime.

### FIELD OF INVENTION

Present invention is related to a sulfide solid electrolyte and a method for stabilizing the said sulfide solid electrolyte, especially to a method for stabilizing the sulfide solid electrolyte by processing with a special gas which is easy to retrieve and with a cost advantage.

The primary application of the sulfide solid electrolyte provided by the present invention is mainly lithium batteries, and will be described and explained hereinafter with details and corresponded drawings. However, the present invention is not intended to be limited to such a primary application. Other similar or equivalent alternations should be considering covered within the claimed scope of the present invention.

### BACKGROUND OF THE INVENTION

Development of solid state electrolyte plays an important role for secondary lithium batteries. The sulfide solid electrolyte has drawn more and more attention by its comparable lithium ion conductivity to ordinary liquid electrolytes but considered as a safer material. However, despite all the advantages of better performances, sulfur atoms in the sulfide solid electrolyte are extremely unstable. It has a high affinity to lithium metal and can easily react with such causing decomposition to whole structure. The reacted product, lithium sulfide, will generate interfacial impedance to the electrode and will further lead to battery failure.

A coating layer applied on an interface between the sulfide solid electrolyte and the electrodes is a current solution to isolate these two affinity materials and to avoid the decomposition of the sulfide solid electrolyte. However, this additional coating layer will increase the complexity of the production and also add extra cost for the material.

Hence, it is eager to have a solution that will overcome or substantially ameliorate at least one or more of the deficiencies of a prior art, or to at least provide a more stable sulfide solid electrolyte with compatible cost and less complexity for the production as an alternative solution to the problems. It is to be understood that, if any prior art information is referred to herein, such reference does not constitute an admission that the information forms part of the common general knowledge in the art.

### SUMMARY OF THE INVENTION

In order to solve the extremely unstable sulfur atom in the sulfide solid electrolyte and also the current coating protected layer will increase the cost and the complexity to the production, the present invention provides a novel sulfide solid electrolyte and its processing method to solve the aforementioned problems or provides an alternative solution to the problems.

In accordance, a first acceptance of the present invention provides a method for stabilizing a sulfide solid electrolyte comprising steps of: providing a sulfide solid electrolyte containing a dissociable phosphorous-sulfur structure; absorbing the carbon dioxide by the sulfide solid electrolyte.

In accordance, a second accept of the present invention provides a sulfide solid electrolyte comprising: a phosphorous-sulfur structure with at least one sulfur atom and one phosphorous atom, and a carbon dioxide is attached on the sulfur atom or forms a sulfur-carbon bond thereon.

In accordance, a third acceptance of the present invention provides a lithium battery comprising the sulfide solid electrolyte as mentioned above.

In accordance, the present invention utilizes easy access carbon dioxide with cost advantage to stabilize the sulfur atoms of the surface of the sulfide solid electrolyte. When applying the processed sulfide solid electrolyte provided by the present invention in a lithium battery, the sulfide solid electrolyte will be more stable after contacting with the lithium metal without easily decomposition after multiple life cycles to remain its performance.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a flow chart of a method for stabilizing a sulfide solid electrolyte in accordance to the present invention.

FIG. 2 is an illustrating figure of a molecular structure of the sulfide solid electrolyte in accordance to the present invention.

FIG. 3 is an XPS result of a preferred embodiment of in accordance to the present invention.

FIG. 4 is a result showing a relationship between differences of current densities, voltages and impedances between the preferred embodiment of the present invention and a comparative example.

FIG. 5 is a result showing a relationship between differences of voltages, impedances and time between the preferred embodiment of the present invention and the comparative example.

### DETAILED DESCRIPTION OF THE PREFERRED EMBODIMENTS

Reference will now be made in detail to the presently preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

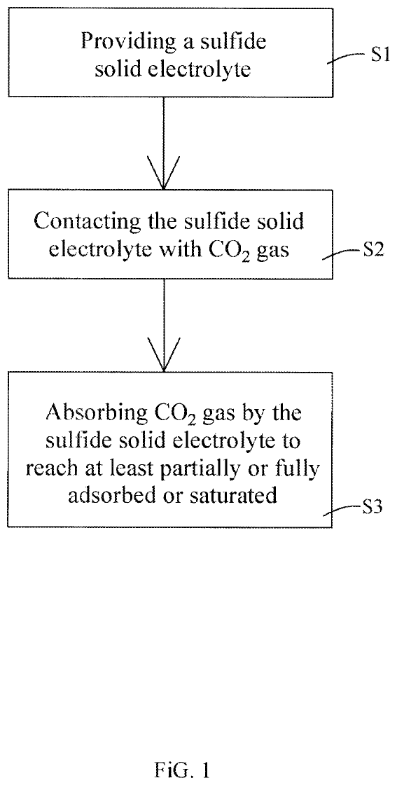

With reference to FIG. 1, the present invention provides a method for stabilizing a sulfide solid electrolyte comprising steps of:

Step S1) providing a sulfide solid electrolyte containing a dissociable phosphorous-sulfur structure;

Step S2) contacting the sulfide solid electrolyte with carbon dioxide; and

Step S3) absorbing the carbon dioxide by the sulfide solid electrolyte.

The aforementioned phosphorous-sulfur structure of the sulfide solid electrolyte is a structure that includes —PS— in its chemical structure, such as —PS₄. Such phosphorous-sulfur structure has the dissociable property which referred to when a voltage is applied to the solid state electrolyte, lithium ions of the solid state electrolyte will move and generate an external current among such structure. The abovementioned step S2 of contacting the sulfide solid electrolyte with carbon dioxide basically includes any methods as long as the sulfide solid electrolyte can contact carbon dioxide. The present invention provides some preferred embodiments to achieve such contacting step.

### Embodiment 1 of the Method for Stabilizing Sulfide Solid Electrolyte

This embodiment uses a vacuum chamber as a processing environment to provide a closed space for sulfide solid electrolyte fully absorbing the carbon dioxide. The sulfide solid electrolyte of this embodiment is Li₆PS₅Cl.

The method of this embodiment comprises steps of:

Step S1) providing a sulfide solid electrolyte, like Li₆PS₅Cl. The sulfide sold electrolyte of this embodiment has a phosphorus-sulfur structure (—PS) with dissociated ability as mentioned above;

Step S2) placing the sulfide solid electrolyte in a closed chamber, or preferably the closed chamber is an airtight chamber or even a vacuum chamber and filling the chamber with carbon dioxide for the sulfide solid electrolyte contacting the carbon dioxide for a period of time; and

Step S3) the phosphorus-sulfur structure of the sulfide solid electrolyte and the carbon dioxide forms a sulfur-carbon bond or sulfur-carbon adsorption effect.

The above-mentioned sulfur-carbon bond is preferred to be the sulfur atom of the phosphorous-sulfur structure of the sulfide solid electrolyte forming a chemical bond with the carbon atom of the carbon dioxide. The sulfur-carbon adsorption effect otherwise is preferably to make the sulfide solid electrolyte adsorb the carbon dioxide at the temperature and pressure which the surface of the sulfide solid electrolyte is at least partially or more preferably fully adsorbed or saturated with carbon dioxide. However, a degree of such saturation is depended on the processing temperature and pressure.

The degree of such saturation is related to the temperature and pressure when contacting the sulfide solid electrolyte with the carbon dioxide. Normally, under room temperature and normal pressure environment, the surface of the sulfide solid electrolyte is able to reach close to 100% of saturation with carbon dioxide. When under a low temperature environment (lower than room temperature), the degree of saturation of the carbon dioxide may increase. The degree of saturation of the carbon dioxide decreases under a high temperature environment (higher than room temperature), to reach at least 30%, or at least 50%, preferably at least 70%, more preferably at least 90%.

### Embodiment 2 of the Method for Stabilizing Sulfide Solid Electrolyte

This embodiment uses dynamic fluid contacting process to provide a carbon dioxide airflow continuing passing by the sulfide solid electrolyte till it fully absorbs the carbon dioxide. The sulfide solid electrolyte of this embodiment is also Li₆PS₅Cl.

The method of this embodiment comprises steps of:

Step S1) providing a sulfide solid electrolyte, like Li₆PS₅Cl. The sulfide solid electrolyte of this embodiment has a phosphorus-sulfur structure (—PS) with dissociated ability as mentioned above;

Step S2) placing the sulfide solid electrolyte in a hollow tube and filling with carbon dioxide in a form of airflow from an opening of the hollow tube; and

Step S3) the phosphorus-sulfur structure of the sulfide solid electrolyte and the carbon dioxide forms a sulfur-carbon bond or sulfur-carbon adsorption effect.

The said sulfur-carbon bond or sulfur-carbon adsorption effect of this embodiment is at the same condition as the first embodiment as mentioned above which preferred to have the surface of the sulfide solid electrolyte at least partially or fully saturated with carbon dioxide.

<Sulfide Solid Electrolyte>

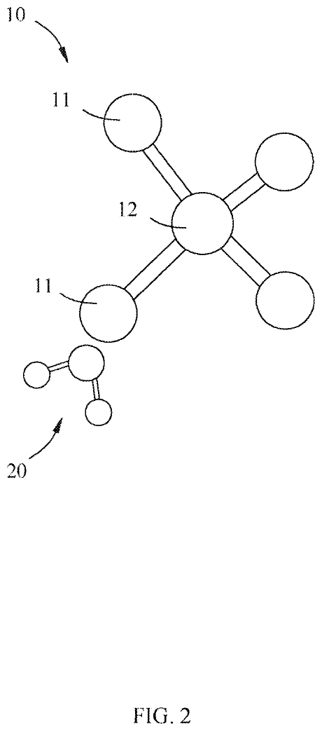

With reference to FIG. 2, the sulfide solid electrolyte obtained by the above-mentioned stabilizing method of the present invention is illustrated. As shown in FIG. 2, the carbon dioxide will firmly attached on the phosphorus-sulfur structure 10 with at least one phosphorus atom 11 and a sulfur atom 12 of the sulfide solid electrolyte. The phosphorus-sulfur structure 10 comprises but is not limited to —PS, —PS₄, or —P₂S₅, etc. To be more specific, the carbon dioxide will firmly attach on the sulfur atom 12 of the phosphorus-sulfur structure 10 to stabilize it and to avoid decomposition. The carbon dioxide can maintain the structure of the sulfide solid electrolyte from moisture, and stably maintain the conductivity for long-term operation.

The preferred embodiments of the sulfide solid electrolyte in the present invention comprises but not limited to (100-x)Li₂S-xP₂S₅, such as Li₇P₃S₁₁, a mixture of (100-x)Li₂S-xP₂S₅ and lithium compound (LiX), such as Li₆PS₅Cl, a mixture of (100-x)Li₂S-xP₂S₅ and sulfur compound (MₓS_{y}), or a mixture of (100-x)Li₂S-xP₂S₅, lithium compound (LiX) and sulfur compound (MₓS_{y}), wherein X in aforementioned formulas are positive integer less than 100. The lithium compound (LiX) comprises lithium chloride, lithium bromide, lithium iodide or combination thereof (which means that X can be Cl, Br, I or a combination thereof). The sulfur compound (MₓS_{y}) comprises germanium disulfide, silicon disulfide, tin disulfide, molybdenum disulfide, aluminum sulfide, nickel sulfide or combination thereof (which means that MₓS_{y} can be GeS₂, SiS₂, SnS₂, MoS₂, Al₂S₃, Ni₃S₂ or combination thereof).

<Validation Tests>

Various validation tests are provided for testing the stability of the sulfide solid electrolyte provided by the present invention. The validation tests are presented with a preferred embodiment of the present invention and a comparative example. First, the sulfide solid electrolyte of the present invention and the comparative example are compacted into test pieces using high pressure (for example 3 tons of pressure) and further laminated with two lithium metal layers. Applying electricity to the test piece with lithium metal layers, the results are as following.

TABLE 1

| | Sulfide solid | Quantity of the |
|---|---|---|
| Sample | electrolyte | test sample |
| Embodiment 1 | Li₆PS₅Cl + CO₂ | 54.8 mg |
| Comparative | Li₆PS₅Cl | 55.1 mg |
| example | (without any treatment) | |

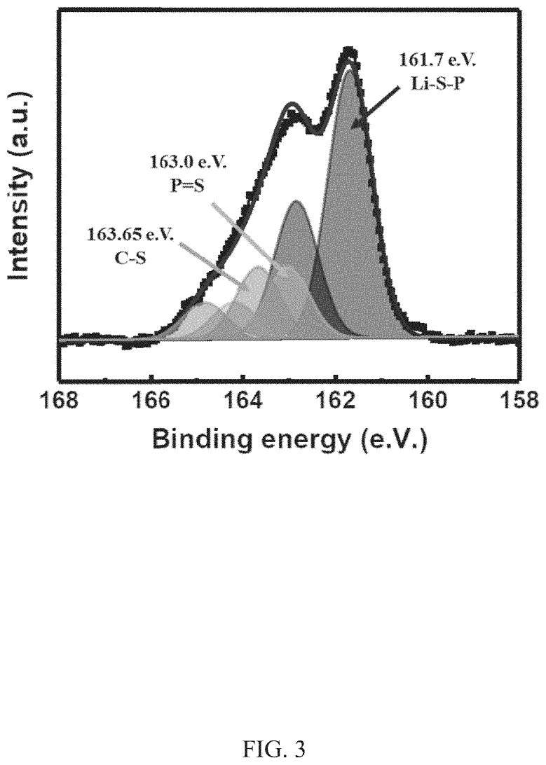

With reference to FIG. 3, an X-ray photoelectron spectroscopy (XPS) result is presented for the embodiment 1 of the present invention from table 1. The result shows that a binding energy of 163.65 e.V. represents a carbon-sulfur bond (C—S) which can consider as a solid proof for the carbon dioxide being firmly attached on the disulfide solid electrolyte for the present invention, especially at a position of sulfur atom of the phosphorus-sulfur structure 10.

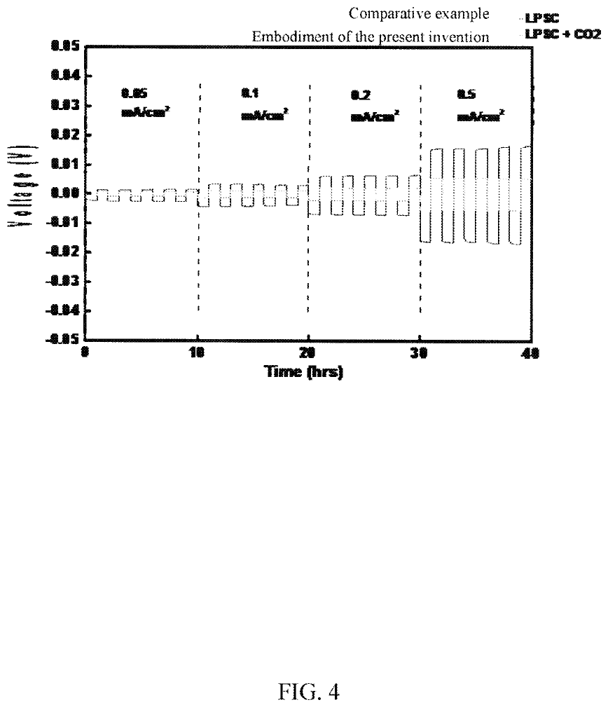

With reference to FIG. 4, a result showing a relationship between current densities, voltages and impedances between the preferred embodiment of the present invention and a comparative example is presented. As shown in the result, for both the embodiment of the present invention and the comparative example, the difference of voltages and impedances is proportional under the same current densities. However, it is clear that the comparative example has greater or larger voltages differences and impedances causing by a formation of lithium sulfide (Li₂S) from the lithium metal reacting with the highly active sulfide solid electrolyte. As such, the sulfide solid electrolyte of the comparative example loses its original function due to the decomposition. On the other hand, the preferred embodiment of the present invention shows the opposite result with smaller and more stable voltages differences and impedances. It is a solid proof that the carbon dioxide can stabilize the sulfur atoms to avoid decomposition, and make the embodiment of the present invention has a more stable life cycle.

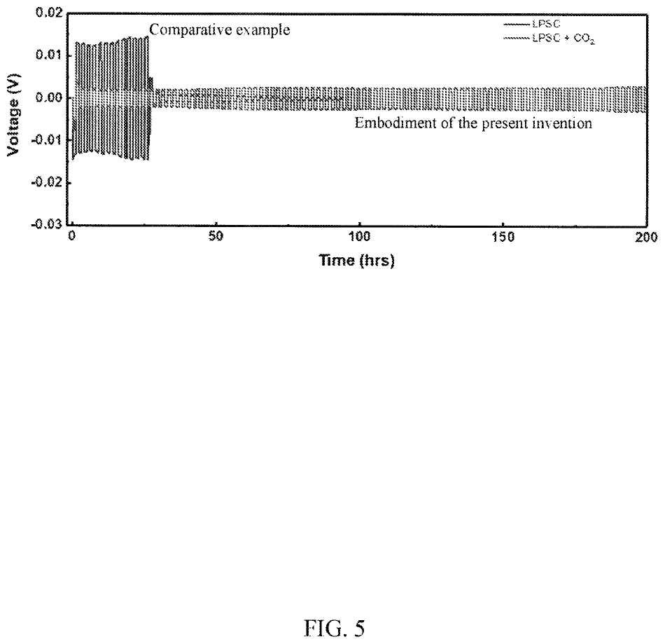

With reference to FIG. 5, a result showing a relationship between differences of voltages, impedances and time between the preferred embodiment of the present invention and the comparative example is presented. The result shows that the comparative example generates a great voltage difference at about 25 hours, and then a short circuit occurs, showing that the sulfide solid electrolyte decomposes and loses its performance without processing with carbon dioxide. The present invention otherwise has stable voltage performance for 200 hours of full life cycles after processing with carbon dioxide indicating that the sulfide solid electrolyte is not decomposed with a more stable structure.

The sulfide solid electrolyte provided by the present invention can be applied in lithium metal batteries, including solid lithium metal batteries or non-solid lithium metal batteries.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for stabilizing a sulfide solid electrolyte comprising steps of:
providing a sulfide solid electrolyte containing a dissociable phosphorous-sulfur structure;
contacting the sulfide solid electrolyte with carbon dioxide; and
absorbing the carbon dioxide by the sulfide solid electrolyte.

2. The method as claimed in claim 1, wherein: the phosphorus-sulfur structure of the sulfide solid electrolyte and the carbon dioxide form a sulfur-carbon bond or sulfur-carbon adsorption effect.

3. The method as claimed in claim 2, wherein: the sulfur-carbon adsorption effect is to make the sulfide solid electrolyte adsorb the carbon dioxide at the temperature and pressure which the surface of the sulfide solid electrolyte is at least partially or fully adsorbed or saturated with carbon dioxide.

4. The method as claimed in claim 1, wherein: to contact the sulfide solid electrolyte with the carbon dioxide by placing the sulfide solid electrolyte in a closed chamber, and filling the closed chamber with carbon dioxide for the sulfide solid electrolyte contacting the carbon dioxide for a period of time.

5. The method as claimed in claim 2, wherein: to contacting the sulfide solid electrolyte with the carbon dioxide by placing the sulfide solid electrolyte in a closed chamber, and filling the closed chamber with carbon dioxide for the sulfide solid electrolyte contacting the carbon dioxide for a period of time.

6. The method as claimed in claim 3, wherein: to contacting the sulfide solid electrolyte with the carbon dioxide by placing the sulfide solid electrolyte in an closed chamber, and filling the closed chamber with carbon dioxide for the sulfide solid electrolyte contacting the carbon dioxide for a period of time.

7. The method as claimed in claim 1, wherein: to contacting the sulfide solid electrolyte with the carbon dioxide by placing the sulfide solid electrolyte in a hollow tube and filling with carbon dioxide in a form of airflow from an opening of the hollow tube.

8. The method as claimed in claim 2, wherein: to contacting the sulfide solid electrolyte with the carbon dioxide by placing the sulfide solid electrolyte in a hollow tube and filling with carbon dioxide in a form of airflow from an opening of the hollow tube.

9. The method as claimed in claim 3, wherein: to contacting the sulfide solid electrolyte with the carbon dioxide by placing the sulfide solid electrolyte in a hollow tube and filling with carbon dioxide in a form of airflow from an opening of the hollow tube.

10. The method as claimed in claim 1, wherein: the sulfide solid electrolyte comprises (100-x)Li₂S-xP₂S₅, a mixture of (100-x)Li₂S-xP₂S₅ and lithium compound (LiX), a mixture of (100-x)Li₂S-xP₂S₅ and sulfur compound (MₓS_{y}), or a mixture of (100-x)Li₂S-xP₂S₅, lithium compound (LiX) and sulfur compound (MₓS_{y}), wherein X in aforementioned formulas are positive integer less than 100.

11. The method as claimed in claim 2, wherein: the sulfide solid electrolyte comprises (100-x)Li₂S-xP₂S₅, a mixture of (100-x)Li₂S-xP₂S₅ and lithium compound (LiX), a mixture of (100-x)Li₂S-xP₂S₅ and sulfur compound (MₓS_{y}), or a mixture of (100-x)Li₂S-xP₂S₅, lithium compound (LiX) and sulfur compound (MₓS_{y}), wherein X in aforementioned formulas are positive integer less than 100.

12. The method as claimed in claim 3, wherein: the sulfide solid electrolyte comprises (100-x)Li₂S-xP₂S₅, a mixture of (100-x)Li₂S-xP₂S₅ and lithium compound (LiX), a mixture of (100-x)Li₂S-xP₂S₅ and sulfur compound (MₓS_{y}), or a mixture of (100-x)Li₂S-xP₂S₅, lithium compound (LiX) and sulfur compound (MₓS_{y}), wherein X in aforementioned formulas are positive integer less than 100.

13. The method as claimed in claim 10, wherein: the lithium compound comprises lithium chloride, lithium bromide, lithium iodide or combination thereof; and the sulfur compound comprises germanium disulfide, silicon disulfide, tin disulfide, molybdenum disulfide, aluminum sulfide, nickel sulfide or combination thereof.

14. The method as claimed in claim 11, wherein: the lithium compound comprises lithium chloride, lithium bromide, lithium iodide or combination thereof; and the sulfur compound comprises germanium disulfide, silicon disulfide, tin disulfide, molybdenum disulfide, aluminum sulfide, nickel sulfide or combination thereof.

15. The method as claimed in claim 12, wherein: the lithium compound comprises lithium chloride, lithium bromide, lithium iodide or combination thereof; and the sulfur compound comprises germanium disulfide, silicon disulfide, tin disulfide, molybdenum disulfide, aluminum sulfide, nickel sulfide or combination thereof.

16. A sulfide solid electrolyte comprising: a phosphorous-sulfur structure with at least one sulfur atom and one phosphorous atom, and a carbon dioxide is attached on the sulfur atom or forms a sulfur-carbon bond thereon.

17. The electrolyte as claimed in claim 16, wherein: the sulfide solid electrolyte comprises (100-x)Li₂S-xP₂S₅, a mixture of (100-x)Li₂S-xP₂S₅ and lithium compound (LiX), a mixture of (100-x)Li₂S-xP₂S₅ and sulfur compound (MₓS_{y}), or a mixture of (100-x)Li₂S-xP₂S₅, lithium compound (LiX) and sulfur compound (MₓS_{y}), wherein X in aforementioned formulas are positive integer less than 100.

18. The electrolyte as claimed in claim 17, wherein: the lithium compound comprises lithium chloride, lithium bromide, lithium iodide or combination thereof; and the sulfur compound comprises germanium disulfide, silicon disulfide, tin disulfide, molybdenum disulfide, aluminum sulfide, nickel sulfide or combination thereof.

19. A lithium battery comprising the sulfide solid electrolyte as claimed in claim 16.
